(19) United States
(12) Patent Application Publication
(10) Pub. No.: US 2017/0359624 A1
(43) Pub. Date: Dec. 14, 2017

(54) MULTI-VIEW POINT/LOCATION OMNI-DIRECTIONAL RECORDING AND VIEWING

(71) Applicant: SPHERE OPTICS COMPANY, LLC, Syracuse, NY (US)

(72) Inventors: Robert S. Englert, Jamesville, NY (US); Meyer J. Giordano, Syracuse, NY (US)

(21) Appl. No.: 15/615,030

(22) Filed: Jun. 6, 2017

Related U.S. Application Data
(60) Provisional application No. 62/347,167, filed on Jun. 8, 2016.

(51) Int. Cl. H04N 21/472; G06Q 20/12; H04N 21/4725; A63F 13/792; G06F 3/048

(52) U.S. Cl. CPC H04N 21/47211; A63F 13/792; G06F 3/048; H04N 21/4725; G06Q 20/1235

(57) ABSTRACT

Aspects providing multiple different and selectable viewpoints for displaying graphic image content of an environment. Thus, a computer processor is configured to cause a graphic display device to display a selectable viewpoint identifier within a display of image content presented to a user; display an information item within the graphic display that is associated with the selectable viewpoint identifier and that provides information of selection of the selectable viewpoint identifier, or of a content viewpoint of the associated selectable viewpoint identifier; and change the display of image content presented to the user on the graphic display device from the current view to the content viewpoint of the associated selectable viewpoint identifier, in response to selection of the selectable viewpoint identifier.

### FIELD OF THE INVENTION

Aspects of the present invention relate to selecting and presenting visual image information from multiple perspectives and viewpoints with respect to a reference environment, for use in photographic recreations and representations.

### BACKGROUND

Virtual reality (VR) refers to the replacement of sensory perception data of an environment inhabited by a user with computer-generated data, in some aspects to enable a user to experience an entirely different world from the present physical location of the user. For example, a user at home during cold winter months may engage a VR device to convey imagery and sounds from a beach vacation destination many miles away. Augmented reality (AR) refers to presentations of combinations of real-world and generated elements, sometimes by processing a camera feed through a computer to add generated elements before displaying it to the user, such as a heads-up display of navigation routing overlay that is superimposed on a camera feed of a street presently being travelled by the user. Some systems may provide both VR and AR capabilities, wherein an AR display device that blends real-world camera image feeds with computer generated data may be used to generate VR displays by dropping the real-world image data from a camera feed, leaving only generated or artificial world views.

Photographic depictions, transmissions, recreations and representations of the real world may capture image information representative of visible physical surroundings by using lens elements to focus light information on recording or transmission mediums (for example, camera sensors, film, light sensitive arrays, etc.) VR games, for example “The Lab™,” and other graphic applications enable users (players) to trans-locate between visible spatial locations. (THE LAB is a trademark of the Valve Corporation in the United States or other countries.) Different locations are identified inside the virtual game space and players can select these locations to experience a different viewpoint. FIG. 1 is a photographic representation of a “screen capture” view from THE LAB.

### SUMMARY

In one aspect of the present invention, a computerized method for providing multiple different and selectable viewpoints for displaying graphic image content of an environment includes executing steps on a computer processor. Thus, a computer processor is configured to display a selectable viewpoint identifier within a display of image content presented to a user on a graphic display device; display an information item within the graphic display that is associated with the selectable viewpoint identifier and that provides information of selection of the selectable viewpoint identifier, or of a content viewpoint of the associated selectable viewpoint identifier; and changes the display of image content presented to the user on the graphic display device from the current view to the content viewpoint of the associated selectable viewpoint identifier, in response to selection of the selectable viewpoint identifier.

In another aspect, a system has a hardware processor in circuit communication with a computer readable memory and a computer-readable storage medium having program instructions stored thereon. The processor executes the program instructions stored on the computer-readable storage medium via the computer readable memory and is thereby configured to display a selectable viewpoint identifier within a display of image content presented to a user on a graphic display device; display an information item within the graphic display that is associated with the selectable viewpoint identifier and that provides information of selection of the selectable viewpoint identifier, or of a content viewpoint of the associated selectable viewpoint identifier; and changes the display of image content presented to the user on the graphic display device from the current view to the content viewpoint of the associated selectable viewpoint identifier, in response to selection of the selectable viewpoint identifier.

In another aspect, a computer program product for providing multiple different and selectable viewpoints for displaying graphic image content of an environment has a computer-readable storage medium with computer readable program code embodied therewith. The computer readable hardware medium is not a transitory signal per se. The computer readable program code includes instructions for execution which cause the processor to display a selectable viewpoint identifier within a display of image content presented to a user on a graphic display device; display an information item within the graphic display that is associated with the selectable viewpoint identifier and that provides information of selection of the selectable viewpoint identifier, or of a content viewpoint of the associated selectable viewpoint identifier; and changes the display of image content presented to the user on the graphic display device from the current view to the content viewpoint of the associated selectable viewpoint identifier, in response to selection of the selectable viewpoint identifier.

### BRIEF DESCRIPTION OF THE DRAWINGS

FIG. 1 is a photographic representation of a screen capture view according to an aspect of the present invention.

FIG. 2 is a flow chart illustration of a process or system aspect of the present invention.

FIG. 3 is a photographic representation of a screen capture view according to an aspect of the present invention.

FIG. 4 is a photographic representation of a screen capture view according to an aspect of the present invention.

FIG. 5 is a schematic illustration of a structure of an embodiment of the present invention.

FIG. 6 is a schematic illustration of a structure of another embodiment of the present invention.

FIG. 7 is a schematic illustration of a structure of another embodiment of the present invention.

FIG. 8 is a schematic illustration of a programmable device implementation according to an aspect of the present invention.

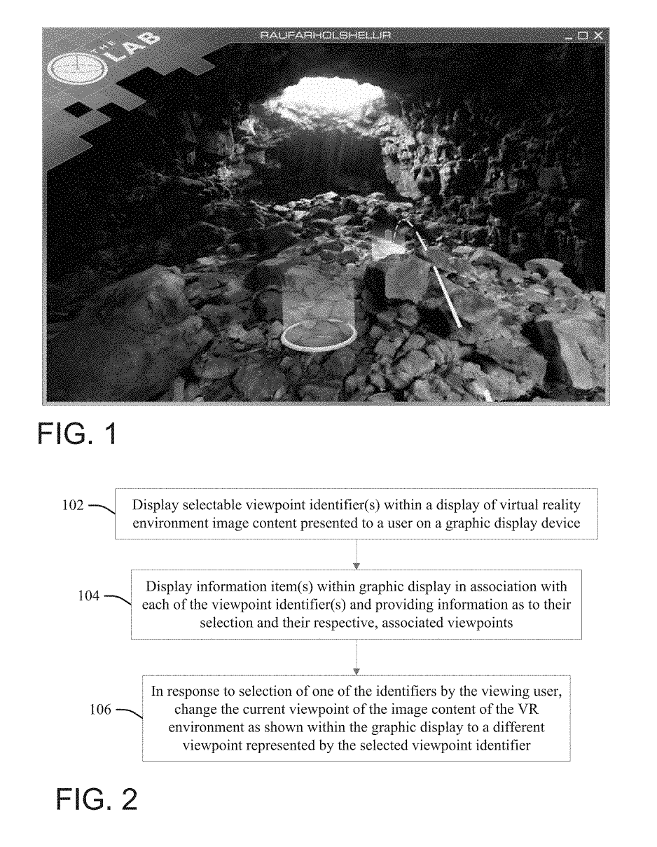

### DETAILED DESCRIPTION

The ability to acquire visual imagery and image information over a full 360 degree horizontal by 180 degree vertical field of view (an “omnidirectional” field of view) is desirable for VR video production and other applications. Examples include first person remote control of robotics, surveillance and security monitoring, exploration of inaccessible spaces (collapsed structures, the interior of the human body), computer vision, and still others will be apparent to one skilled in the art.

FIG. 2 illustrates a process or system aspect according to the present invention for providing multiple different and selectable viewpoints for displaying graphic image content of a VR environment. Illustrative but not limiting or exhaustive examples of graphic display of image content of a VR environment presented to a viewing user include playback of pre-recorded or generated video game content, live streaming of game content or live event video streams, etc.

At 102 one or more selectable viewpoint identifiers are displayed within a display of the image content presented to a user on a graphic display device (computer or mobile phone screen, etc.). Illustrative but not limiting or exhaustive examples of the viewpoint identifiers include overlaid digital visual indicators, graphic markers, flags, icons, etc.) The viewpoint identifiers are each linked to a different content viewpoint.

In some embodiments at 104 different information items are displayed within the graphic display that are each associated with the viewpoint identifier(s) and provide information as to their selection and their respective, associated viewpoints. Illustrative but not limiting or exhaustive examples of the displayed information items include source and location of a viewpoint relative to the current viewpoint of the display or to the viewing user; thumb-nails or other representations of the content as viewed from the associated viewpoint; cost of changing the current view to the viewpoint associated with selection of the viewpoint identifier; conditions for implementing a selection, etc.

In response to selection of one of the identifiers by the viewing user, at 106 the process or system changes the current (primary) viewpoint of the image content of the VR environment as shown within the graphic display to a different viewpoint represented by the selected viewpoint identifier, in some examples subject to the cost or conditions displayed at 104, or to other conditions and costs defined by other agreement terms applicable to the viewing user. The selection by the viewer at 106 may be by cursor or other graphical user interface (GUI) routine of a particular viewpoint identifier, or the selection may be of a viewpoint from a list or matrix display of thumb-nails of view, from a menu of viewpoint names and/or locations (for example, with respect to music event “backstage,” “front row,” “balcony,” “on stage”), etc.

Aspects of the present invention enable the provision within network structures of multiple omnidirectional capture devices (from both single camera and multi-camera array systems and devices) in different locations. In some examples, viewers are enabled to easily switch to different viewpoints within a shared recorded event or location (i.e. concert, performance, sporting event, etc.) during playback or live streaming of said event. By networking or linking a series of omnidirectional recording devices, systems and processes according to the present invention present to viewers multiple, first person perspectives or viewpoints, at different geo-spatial locations.

Aspects network or link multiple omnidirectional camera locations/viewpoints, wherein each location may be identified either during or after recording of image information at the location of each capture device. Location identification may be accomplished via a variety of methods and systems, and illustrative but not limiting or exhaustive examples include radio signal, radio-frequency identification (RFID), Wireless Fidelity (WIFI), global positioning satellite (GPS), and manual and automated specification system and processes.

When viewing playback (or live streaming) from any linked viewpoint, a viewer can choose to see identifiers of each linked viewpoint (this may be an overlaid digital visual indicator or graphic marker, flag) and select that marker to change primary viewpoint location. The viewer may also choose to select viewpoint from thumb-nails of view or from a menu of viewpoint names/locations (i.e. backstage, front row, balcony, on stage, etc.).

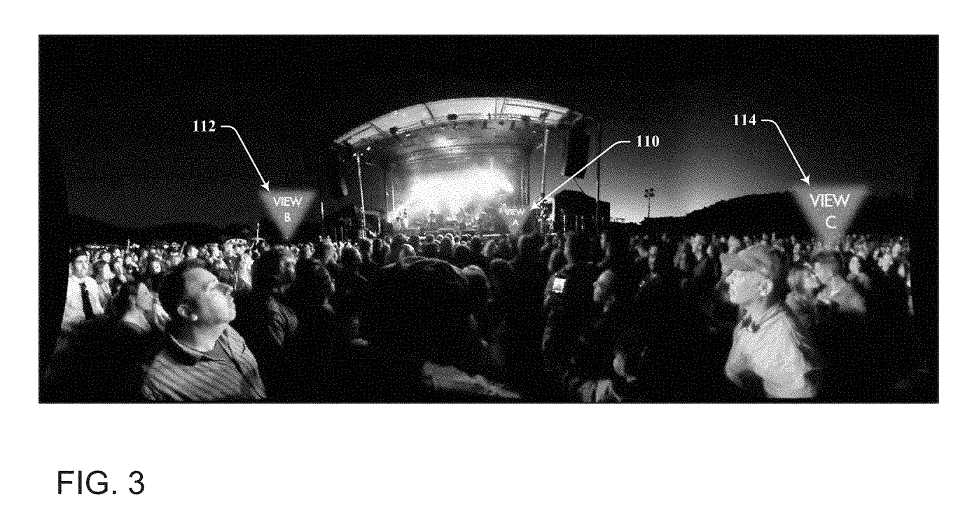

FIG. 3 illustrates one example wherein three different triangular selectable viewpoint identifiers 110 (“View A”), 112 (“View B”) and 114 (“View C”) are depicted within a display of VR music concert image content that is presented to a user on a graphic display device. Each of the selectable viewpoint identifiers represents a different vantage point that are between the user's viewpoint and the stage, and is therefore closer to the stage than the viewpoint of the current view. Their different relative proximities to the user as defined by the current viewpoint, or to the stage of musicians, are also indicated by differences in the triangular shapes used to illustrate each: 110 (“View A”) is the smallest, indicating that it is furthest away from the current viewpoint, and in this viewpoint orientation therefore also closest to the stage, thereby affording the best improvement over the current view if the viewing user wishes to view the musicians on stage. In contrast, 114 (“View C”) has the largest triangular shape, indicating it is more proximate to the user's vantage point in the current view, and further from the stage, than either of the other two options 112 and 110.

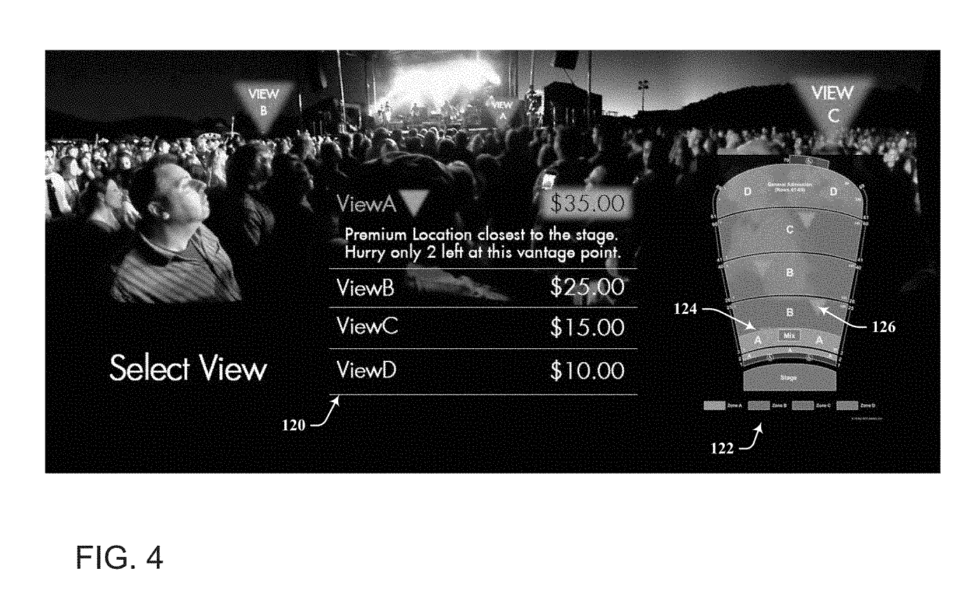

FIG. 4 illustrates another example of the view of FIG. 3 that also includes menu overlay information items 120 and 122 (pursuant to step 104 of FIG. 2). Menu overlay items may show selectable viewpoint identifier (marker) locations in different formats, including menu, map, spatial location formats. In the present example, information item 120 is a price list overlay that informs the viewing user of the cost for viewing the VR concert content from their current view vantage point, (View D) is ten U.S. dollars; that changing the current view to the “premium location closest to the stage” viewpoint of selectable viewpoint identifier 110 (“View A”) will cost thirty-five U.S. dollars, and further that only two opportunities are left at this level; and that the cost for selection instead of either of the other selectable viewpoint identifiers 112 (“View B”) and 114 (“View C”) is twenty-five U.S. dollars and fifteen U.S. dollars, respectively.

Information item 122 is a graphic depiction of a top perspective (bird's eye) view of the viewer assembly area of the venue hosting the musical event, wherein the Views A, B, C and D are each depicted within (correlated with) different respective seating sections within the assembly area, and the locations of the available views 110, 112 and 114 are also plotted within the seating sections: thus, marker 124 is a plot of the location of View A 110 within the View A section, and marker 126 is a plot of the location of View B 112 within the View B section.

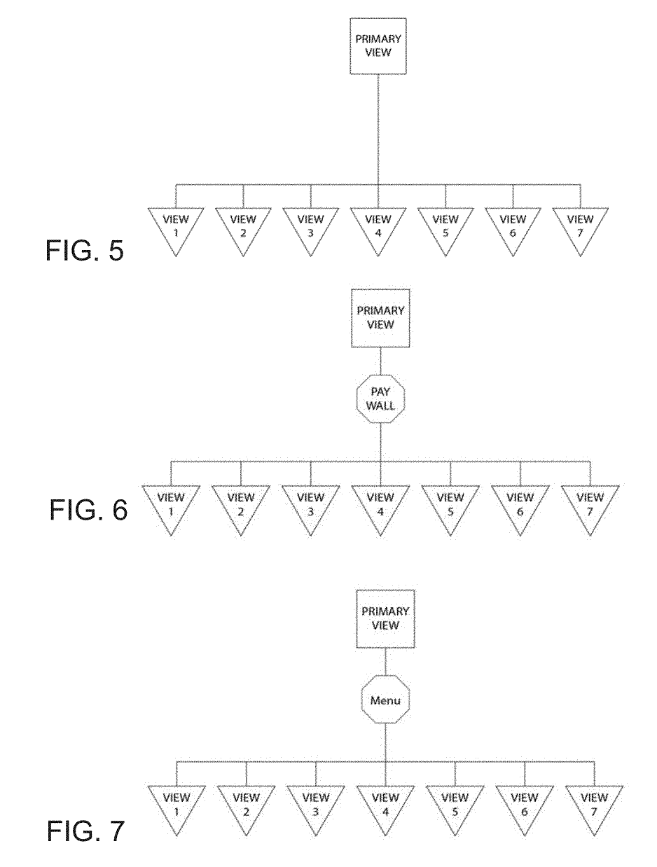

FIGS. 5-7 depict schematic structures of embodiments of the present invention. FIG. 5 shows a direct connection to each of a plurality of different views that are directly selectable for providing a view of an environment or event to the user; in this example, seven views “View 1” through “View 7.” For example, the selectable viewpoint identifiers 110, 112 and 114 of FIG. 3 may each be associated with a different one of the seven views, and direct selection of one of said viewpoint identifiers 110, 112 or 114 will cause a graphic display device used by the selecting user to change from a current “primary” view of the user to the associated viewpoint.

FIG. 6 illustrates an alternative to the structure of FIG. 5, wherein the user must meet the conditions of a paywall to select one of the other views and change the current, primary view to one of the selected views. FIG. 7 illustrates another alternative to the structures of FIGS. 5 and 6, wherein the user uses a menu item (such as the items 120 and 122 of FIG. 4) to select one of the other views and change the current, primary view to one of the selected views.

When viewing a virtual reality content or “experience” via embodiments of the present invention, users may easily select to have other viewpoint locations visible as an augmented layer of information. The user can then select a different viewpoint through a spatial menu, list view, map, thumbnails or other means (for example, using eye tracking or physical controller). Aspects can provide access to various viewpoints instantly (and freely), or the user may have to go through a paywall where certain viewpoints are restricted or require authorization. Once selected, the user's viewpoint will change.

Some examples use differential tiers or criteria for selection, for example, primary, secondary and tertiary markers representing different types of devices. Access to these devices can be open or closed, in some instances differentially based on their relative tier or criteria status. In one example, a primary network includes all proprietary content controlled by an entity and separated by a paywall, wherein a secondary marker represents an individual consumer who freely allows shared access to his or her feed.

A user may choose varying degrees of acuity, based on individual input devices or their status relative to other similar devices. For example, mobile phone devices may be configured to allow one or more of WIFI, GPS, near-field and RFID connections to other devices, wherein individual devices may be paired to a user's phone.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment .combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes transitory, propagation or carrier wave signals or subject matter and includes an electronic, magnetic, optical or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that does not propagate but can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic or optical forms or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flowchart and/or block diagram block or blocks.

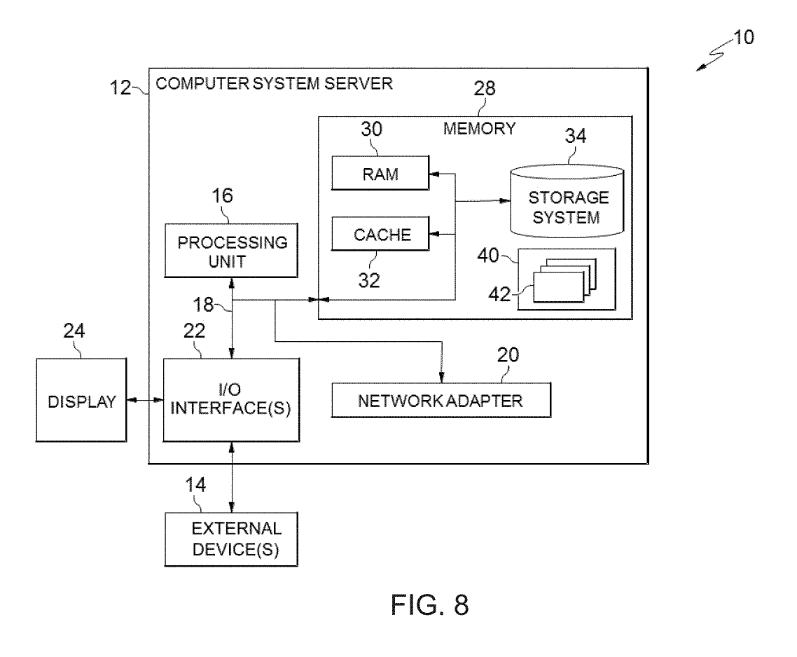

FIG. 8 is a schematic of an example of a programmable device implementation 10 according to an aspect of the present invention, which may function as a cloud computing node. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating systems, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various aspects of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for providing multiple different and selectable viewpoints for displaying graphic image content of an environment, the method comprising executing on a processor the steps of:
displaying a selectable viewpoint identifier within a display of image content presented to a user on a graphic display device;
displaying an information item within the graphic display that is associated with the selectable viewpoint identifier and that provides information that is selected from the group consisting of selection of the selectable viewpoint identifier, and a content viewpoint of the associated selectable viewpoint identifier; and
in response to selection of the selectable viewpoint identifier, changing the display of image content presented to the user on the graphic display device from the current view to the content viewpoint of the associated selectable viewpoint identifier.

2. The method of claim 1, wherein the step of changing the display of image content presented to the user on the graphic display device from the current view to the content viewpoint of the associated selectable viewpoint identifier in response to the selection of the selectable viewpoint identifier is conditional on the determining that viewing user performs an act selected from the group consisting of paying the cost and observing a condition displayed by the information item.

3. The method of claim 1, wherein the selectable viewpoint identifier is selected from the group consisting of an overlaid digital visual indicator, a graphic marker, a flag, an icon and a thumbnail image.

4. The method of claim 1, wherein the display of image content presented to the user on the graphic display device is selected from the group consisting of playback of pre-recorded or generated video game content, live streaming of game content, and a live event video stream.

5. The method of claim 1, wherein the information item is selected from the group consisting of a source of the content viewpoint of the associated selectable viewpoint identifier, a location of the content viewpoint of the associated selectable viewpoint identifier relative to the current viewpoint of the display or to the viewing user, a thumb-nail representation of content as viewed from the content viewpoint of the associated selectable viewpoint identifier, a cost of changing the current view to the content viewpoint of the associated selectable viewpoint identifier, and a condition for implementing a switch from the current view to the content viewpoint of the associated selectable viewpoint identifier.

6. The method of claim 1, further comprising:
integrating computer-readable program code into a computer system comprising a processor, a computer readable memory and a computer readable storage medium, wherein the computer readable program code is embodied on the computer readable storage medium and comprises instructions that, when executed by the processor via the computer readable memory, cause the processor to perform the steps of displaying the selectable viewpoint identifier within the display of image content presented to the user on the graphic display device, displaying the information item within the graphic display, and changing the display of image content presented to the user on the graphic display device from the current view to the content viewpoint of the associated selectable viewpoint identifier in response to the selection of the selectable viewpoint identifier.

7. The method of claim 1, wherein the computer-readable program code is provided as a service in a cloud environment.

8. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
displays a selectable viewpoint identifier within a display of image content presented to a user on a graphic display device;
displays an information item within the graphic display that is associated with the selectable viewpoint identifier and that provides information that is selected from the group consisting of selection of the selectable viewpoint identifier, and a content viewpoint of the associated selectable viewpoint identifier; and
in response to selection of the selectable viewpoint identifier, changes the display of image content presented to the user on the graphic display device from the current view to the content viewpoint of the associated selectable viewpoint identifier.

9. The system of claim 8, wherein the processor executes the program instructions stored on the computer-readable storage medium via the computer readable memory and thereby changes the display of image content presented to the user on the graphic display device from the current view to the content viewpoint of the associated selectable viewpoint identifier in response to the selection of the selectable viewpoint identifier conditioned upon determining that a viewing user performs an act selected from the group consisting of paying the cost and observing a condition displayed by the information item.

10. The system of claim 8, wherein the selectable viewpoint identifier is selected from the group consisting of an overlaid digital visual indicator, a graphic marker, a flag, an icon and a thumbnail image.

11. The system of claim 8, wherein the display of image content presented to the user on the graphic display device is selected from the group consisting of playback of pre-recorded or generated video game content, live streaming of game content, and a live event video stream.

12. The system of claim 8, wherein the information item is selected from the group consisting of a source of the content viewpoint of the associated selectable viewpoint identifier, a location of the content viewpoint of the associated selectable viewpoint identifier relative to the current viewpoint of the display or to the viewing user, a thumb-nail representation of content as viewed from the content viewpoint of the associated selectable viewpoint identifier, a cost of changing the current view to the content viewpoint of the associated selectable viewpoint identifier, and a condition for implementing a switch from the current view to the content viewpoint of the associated selectable viewpoint identifier.

13. A computer program product for providing multiple different and selectable viewpoints for displaying graphic image content of an environment, the computer program product comprising:
a computer readable storage medium having computer readable program code embodied therewith, wherein the computer readable storage medium is not a transitory signal per se, the computer readable program code comprising instructions for execution by a processor that cause the processor to:
display a selectable viewpoint identifier within a display of image content presented to a user on a graphic display device;
display an information item within the graphic display that is associated with the selectable viewpoint identifier and that provides information that is selected from the group consisting of selection of the selectable viewpoint identifier, and a content viewpoint of the associated selectable viewpoint identifier; and
in response to selection of the selectable viewpoint identifier, change the display of image content presented to the user on the graphic display device from the current view to the content viewpoint of the associated selectable viewpoint identifier.

14. The computer program product of claim 13, wherein the computer readable program code instructions for execution by the processor further cause the processor to change the display of image content presented to the user on the graphic display device from the current view to the content viewpoint of the associated selectable viewpoint identifier in response to the selection of the selectable viewpoint identifier conditioned upon determining that a viewing user performs an act selected from the group consisting of paying the cost and observing a condition displayed by the information item.

15. The computer program product of claim 13, wherein the selectable viewpoint identifier is selected from the group consisting of an overlaid digital visual indicator, a graphic marker, a flag, an icon and a thumbnail image.

16. The computer program product of claim 13, wherein the display of image content presented to the user on the graphic display device is selected from the group consisting of playback of pre-recorded or generated video game content, live streaming of game content, and a live event video stream.

17. The computer program product of claim 13, wherein the information item is selected from the group consisting of a source of the content viewpoint of the associated selectable viewpoint identifier, a location of the content viewpoint of the associated selectable viewpoint identifier relative to the current viewpoint of the display or to the viewing user, a thumb-nail representation of content as viewed from the content viewpoint of the associated selectable viewpoint identifier, a cost of changing the current view to the content viewpoint of the associated selectable viewpoint identifier, and a condition for implementing a switch from the current view to the content viewpoint of the associated selectable viewpoint identifier.
